(19) United States
(12) Patent Application Publication
(10) Pub. No.: US 2026/0314832 A1
(43) Pub. Date: Oct. 15, 2026

(54) CELLULAR CUSHION AND METHOD FOR MANUFACTURING A CELLULAR CUSHION

(71) Applicant: Etac AB, Kista (SE)

(72) Inventors: Germund LARSSON, Reftele (SE); Gabriel MOLINA, Anderstorp (SE)

(21) Appl. No.: 19/466,298

(22) Filed: Jan. 31, 2026

(30) Foreign Application Priority Data
Feb. 5, 2025 (EP) 25155943

(51) Int. Cl. A47C 7/14; A47C 7/02

(52) U.S. Cl. CPC A47C 7/142; A47C 7/021

(57) ABSTRACT

A cellular cushion having a lower layer, an intermediate layer, an upper layer, and a plurality of hollow cells coupled to the upper layer. The upper layer has a plurality of holes. First channels are formed between the lower layer and the intermediate layer. Second channels are formed between the intermediate layer and the upper layer. The hollow cells can be in fluid communication with each other through the plurality of holes of the upper layer and the second channels. The hollow cells and the holes of the upper layer are arranged on top of and aligned with the first channels, whereby, when the first channels are filled with fluid and pressurized, the intermediate layer is pressed towards the upper layer, whereby the intermediate layer closes the plurality of holes of the upper layer.

### RELATED APPLICATION DATA

This application claims the benefit of European Application No. 25155943, filed Feb. 5, 2025, the content of which is incorporated herein by reference in its entirety.

### TECHNICAL FIELD

The present invention relates generally to cellular cushions and methods for manufacturing such cellular cushions.

### BACKGROUND ART

Individuals that are in a seated position for a long time, such as individuals confined to wheelchairs, may run the risk of tissue breakdown and development of pressure sores, which are dangerous to the individual and difficult to cure. More specifically, as such individuals are primarily in a seated position for extended periods of time, their weight may be concentrated in the bonier portions of the individual’s buttocks. Over time, blood flow to such areas may decrease, causing tissue to break down in these areas.

To facilitate reducing the weight concentration of such individuals, there are cellular cushions that facilitate distributing the individual's weight over a larger area and across the individual's buttocks, whereby the individual’s possible weight concentration in smaller areas is decreased. Such cellular cushions include a plurality of hollow air-filled cells which project upwardly from a common base. The plurality of air-filled cells are coupled in flow communication through the base. Hereby, the air within such cells is at the same pressure throughout the plurality of cells, and as such, each cell exerts the same pressure against an individual's buttocks.

However, although such cushions do facilitate distributing the weight across the individual’s buttocks, the seated individual may in some such cushions experience some seating instability. To facilitate increasing the stability of the individual for cushions comprising air-fillable cells, at least some known cellular cushions are divided into isolated zones of cells, wherein the cells of each zone are only in flow communication with the cells within their zone. By varying the pressure between the isolated zones, the individual may be able to increase their stability on the cellular cushion depending on the physical condition of the individual. However, the isolated zones may provide only slightly more stability to those individuals that lack muscular strength in their pelvis and/or thigh regions. Furthermore, such cellular cushions may not provide any additional stability to individuals that have a skeletal deformity, such as a pelvic obliquity. More specifically, within at least some known zoned cushions, such cushions may bottom out to provide little or no cushioning to an individual having a skeletal deformity.

US patent 7434282 B2 shows a cellular cushion in which individual cells can be isolated. Hereby, not just isolated zones but even individual cells can have different air pressure. As a result, such a cushion can be more specifically adapted to an individual’s need than a zoned cushion. Hereby, the individual can be provided with even more stability. The cellular cushion of US 7434282 B2 comprises a bottom layer, a middle layer and a conformal layer arranged on top of the middle layer, the conformal layer comprising the hollow cells. The cellular cushion comprises two separate air systems, a system of first channels between the bottom layer and the middle layer and a system of second channels between the middle layer and the conformal layer. Air is fed between the individual cells via the second channels. The second channels extend between the individual cells in a crossing pattern. Further, the first channels between the bottom layer and the middle layer are also formed in a crossing pattern, but the first channels are angled to the second channels. The crossings of the second channels lie on top of the crossings of the first channels. The second channels can be locked by filling air into the first channels so that the first channels expand, whereby the middle layer is pressed towards the conformal layer, especially at the crossings, whereby the first channels are locked at their crossings. Hereby, no air will flow between the cells. Air pressure in individual cells can then be controlled by: filling the second channels and hereby the hollow cells with air, then manually push out air of the cells which are to have lower pressure, then filling the first channels with air so that the first channels locks the second channels at the crossings.

Even though the cellular cushion of US 7434282 B2 provides a good way of controlling individual cells, there is always an interest of improvements. For example, the manufacturing of cellular cushions may be improved. Consequently, there is a need of an improved cellular cushion for which the cells can be individually controlled.

### SUMMARY OF INVENTION

It is an object of embodiments to address at least one of the problems and issues outlined above. It is an object of embodiments to achieve an improved cellular cushion which cells can be individually controlled. It is possible to achieve at least of one of these objects by cellular cushions and methods for manufacturing cellular cushions as defined in the independent claims.

According to an aspect, a cellular cushion is disclosed comprising a lower layer, an intermediate layer arranged on top of the lower layer and coupled to the lower layer in such a way that first channels for transport of a fluid are formed between the lower layer and the intermediate layer. The cellular cushion further comprises an upper layer arranged on top of the intermediate layer and coupled to the intermediate layer in such a way that second channels for transport of fluid are formed between the upper layer and the intermediate layer. The cellular cushion further comprises a plurality of hollow cells coupled to the upper layer, each of the plurality of hollow cells having a root defined at the upper layer and a tip, each cell extending from the root away from the upper layer towards the tip. Further, the upper layer has a plurality of holes. Each hole is positioned at a respective one of the roots of the plurality of hollow cells. Each hole is smaller than the respective root. The plurality of hollow cells are capable of being in fluid communication with each other through the plurality of holes of the upper layer and the second channels, wherein each of the plurality of hollow cells and each of the holes of the upper layer are arranged on top of and aligned with at least one of the first channels. Hereby, when the first channels are filled with fluid and pressurized, the intermediate layer is pressed towards the upper layer, whereby the intermediate layer closes the plurality of holes of the upper layer and/or the second channels.

As each of the plurality of hollow cells is arranged on top of a first channel and aligned with the first channel, i.e., arranged above a first channel and sharing the same planar position with the first channel, the following will happen when the first channels are being filled with fluid: The intermediate layer is pushed upwards as the first channels are filled with fluid until the intermediate layer bears against the upper layer. Hereby, the holes of the upper layer are closed. Also, the first channels may be closed. This is illustrated in attached FIG. 10. A user of the cellular cushion wanting to let one or more of the hollow cells be without fluid or with less fluid than the rest of the hollow cells, can then act according to the following process: First filling the second channels with fluid whereby the hollow cells are filled through the openings of the upper layer; Then pressing out fluid from the set of cells which are to be without fluid or with less fluid; Thereafter filling the first channels with fluid whereby the second channels are closed. The cellular cushion can then be used with the set of cells un-filled.

Compared to the prior art cellular cushion of US 7434282 B2, the present invention closes the fluid connection between the cells at the roots of the hollow cells, i.e., immediately below the hollow cells instead of at the second channels between the hollow cells, skewed from the hollow cells. By letting the hollow cells be positioned on top of and aligned with the first channels, in other words, let the first channels run below the hollow cells, and have an opening in the upper layer that is smaller than the root of the hollow cells, a secure locking mechanism for locking the individual cells is provided. Also, the positioning of the lower layer, the intermediate layer and the upper layer at manufacture can differ a bit without risking any leakage between cells. In other words, the second channels and/or the openings of the upper layer will be closed even if there is a skew between the layers at mounting. As a result, a more effective production of the cellular cushion can be achieved.

According to another aspect, a method for manufacturing a cellular cushion as disclosed is described. The method comprises welding the intermediate layer to the lower layer so that first welding seams are created, the first welding seams delimiting the first channels, and welding the upper layer to the intermediate layer so that second welding seams are created, the second welding seams delimiting the second channels.

Further possible features and benefits of this solution will become apparent from the detailed description below.

### BRIEF DESCRIPTION OF DRAWINGS

The invention is now described, by way of example, with reference to the accompanying drawings, in which:

FIG. 1 is a perspective view from above of a cellular cushion according to an embodiment.

FIG. 2 is a perspective view from below of a cellular cushion according to an embodiment.

FIG. 3 is a perspective exploded view from above of a cellular cushion according to an embodiment.

FIG. 4 is a perspective exploded view from below of a cellular cushion according to an embodiment.

FIG. 5 is a view from below of the lower layer including the first channels arranged between the lower layer and the intermediate layer, according to an embodiment.

FIG. 6 is a view from above of the upper layer including the second channels arranged between the upper layer and the intermediate layer, according to an embodiment.

FIG. 7 is a schematic view from above illustrating the hollow cells as well as the first and second channels, according to an embodiment.

FIG. 8 is a perspective view from below of a hollow cell layer according to an embodiment.

FIG. 9 is a side view of the cellular cushion of FIG. 1 including a close-up of a part of the cellular cushion in cross-section A-A of FIG. 1, when the second channels are open.

FIG. 10 is a side view of the cellular cushion of FIG. 1 including a close-up of a part of the cellular cushion in cross-section A-A of FIG. 1 when the second channels are closed.

### DESCRIPTION OF EMBODIMENTS

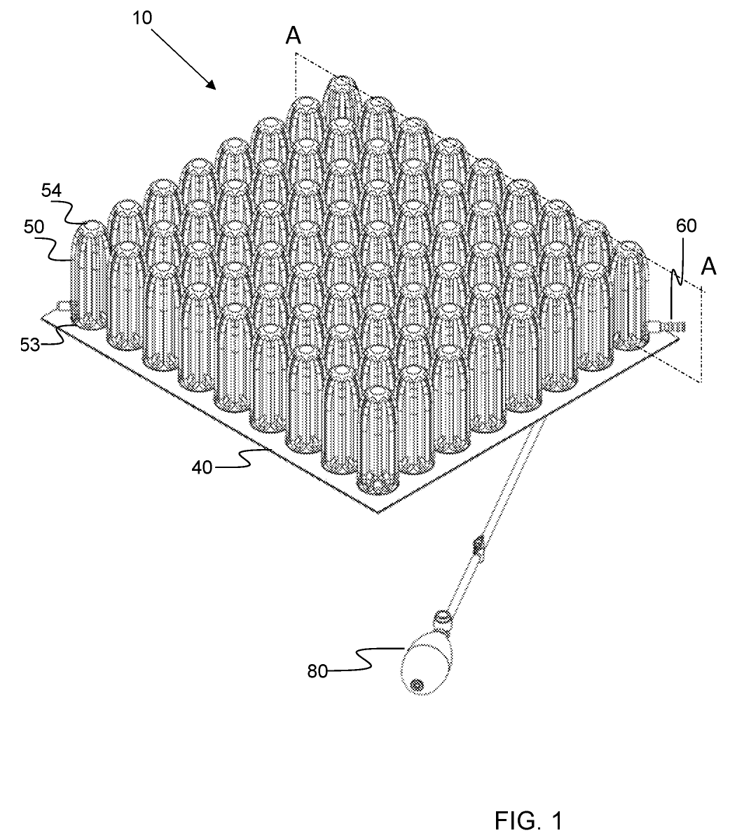

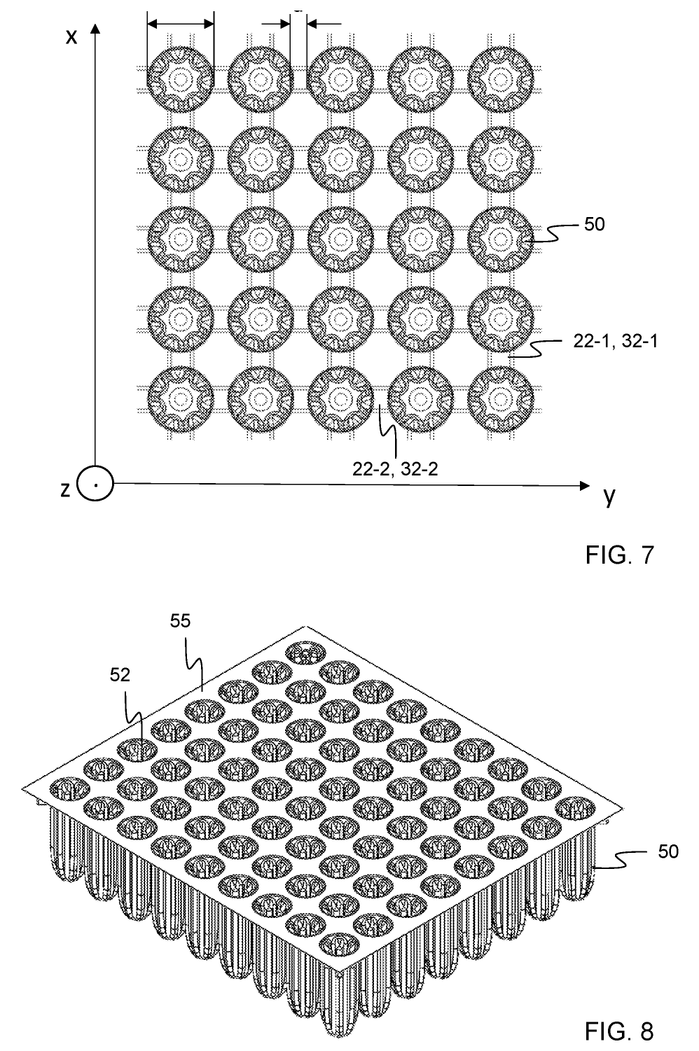

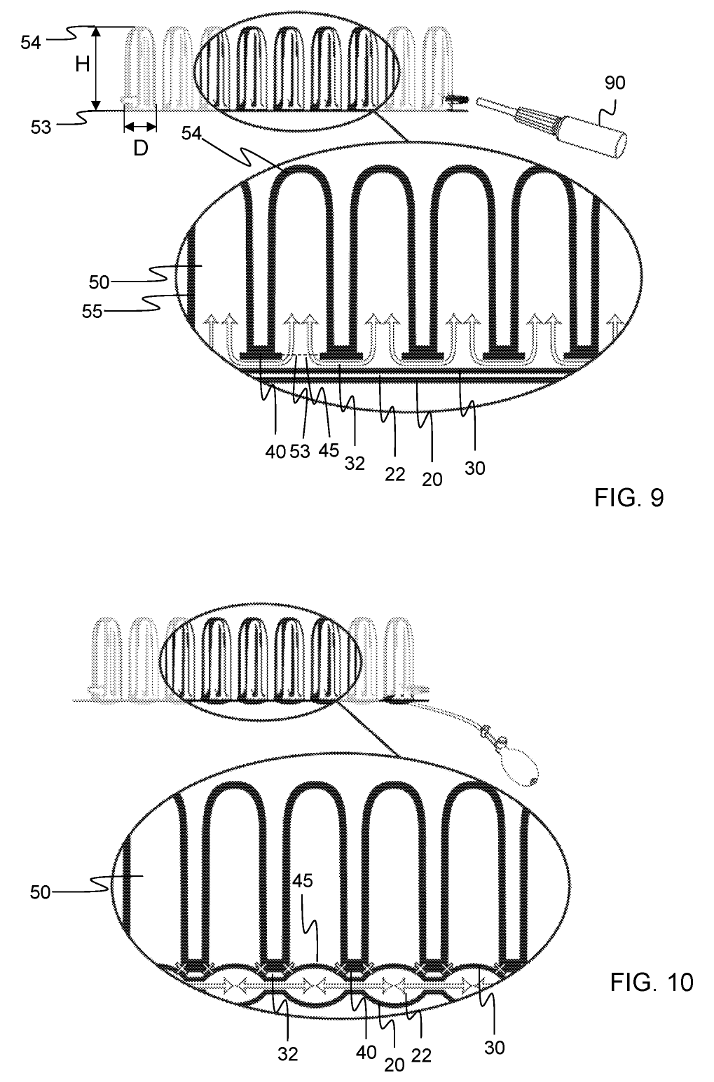

In the following, a detailed description of an embodiment of a cellular cushion is described. FIG. 1 shows a cellular cushion 10 in a perspective view at an angle from above. The cellular cushion 10 comprises a plurality of hollow cells 50. In the example shown, there are 8 * 9 = 72 hollow cells. However, the cellular cushion 10 may have larger or smaller size. Also, even if the shown cellular cushion 10 is square-shaped, other embodiments may have other shapes, such as rectangular, triangular, elliptical, polygonal or circular. The cellular cushion 10 also comprises an upper layer 40 onto which the hollow cells 50 are arranged. The hollow cells 50 each has a root 53 defined at the upper layer 40 and a tip 54. Each cell 50 extends from the root 53 away from the upper layer 40 towards the tip 54. In the exemplary embodiment, the hollow cells 50 are positioned substantially symmetrically across the upper layer 40, such that adjacent cells 50 are separated by a substantially equal distance d, see FIG. 7. In an alternative embodiment, the hollow cells 50 are separated by varying distances. In some embodiments, the cells 50 have the same height H (see FIG. 9) from the root 53 to the tip 54. In some embodiment, the cells 50 have the same diameter D (see FIG. 7 and 9). In some embodiments, the cells 50 are identical. Alternatively, the cells 50 may have mutually different heights and/or diameters. In the embodiment of FIG. 1, each of the cells 50 has a circular cross-section at its root 53. However, other cross-sections may apply, such as square-shaped, rectangular, triangular, elliptical or polygonal. The hollow cells 50 are shown in cross-section in side-view in FIGS. 9 and 10.

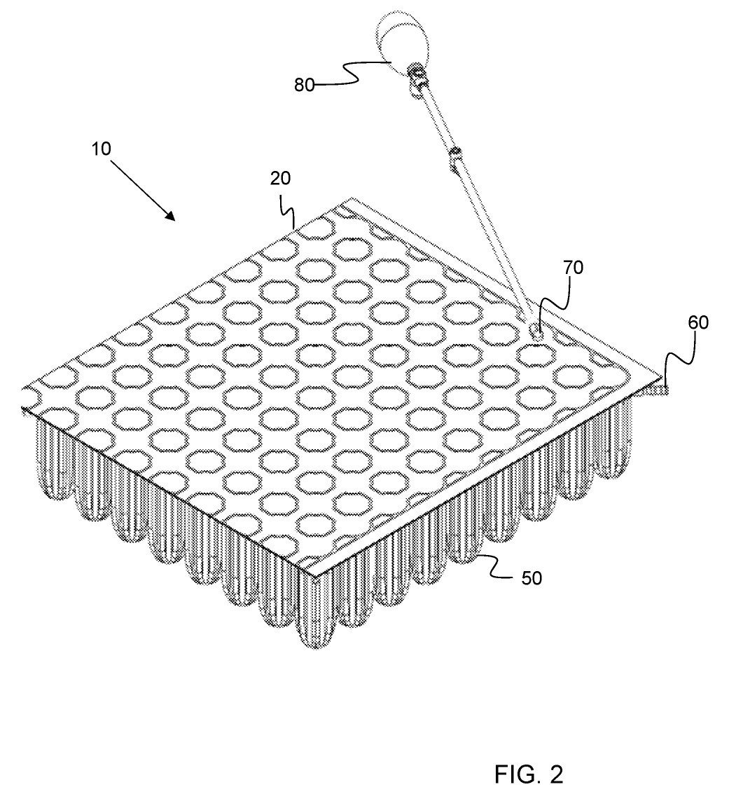

FIG. 1 also shows a first valve 60 connected to one of the hollow cells 50 arranged in a corner of the cellular cushion 10, however, the first valve 60 may be arranged at another position than at the corner of the cellular cushion 10. The first valve 60 is for inflating and deflating of the plurality of hollow cells 50. The first valve 60 has a nozzle to which a pump can be connected for pumping up the hollow cells 50 via the first valve 60. An example of such a pump 90 is shown in FIG. 9. Although only one first valve 60 is shown, there may in other embodiments be more than one first valve 60. In such embodiments, the cellular cushion may be divided into isolated zones of cells, wherein the cells of each zone are only in flow communication with the cells within their zone. Then there is arranged at least one first valve 60 per such zone. Also shown in FIG. 1 is an arrangement 80 for inflating or deflating first channels via a second valve 70 (see FIG. 2). The first channels will be shown and explained further down.

FIG. 2 shows an embodiment of the cellular cushion 10 in a perspective view from below. Here, a bottom layer 20 of the cellular cushion is shown as well as the second valve 70 to which the arrangement 80 for inflating or deflating first channels is arranged. The arrangement 80 for inflating or deflating first channels may be stationary arranged to the second valve 70 as part of the cellular cushion 10 or the arrangement 80 may be an add-on that is connected to the second valve 70 when it is to be used.

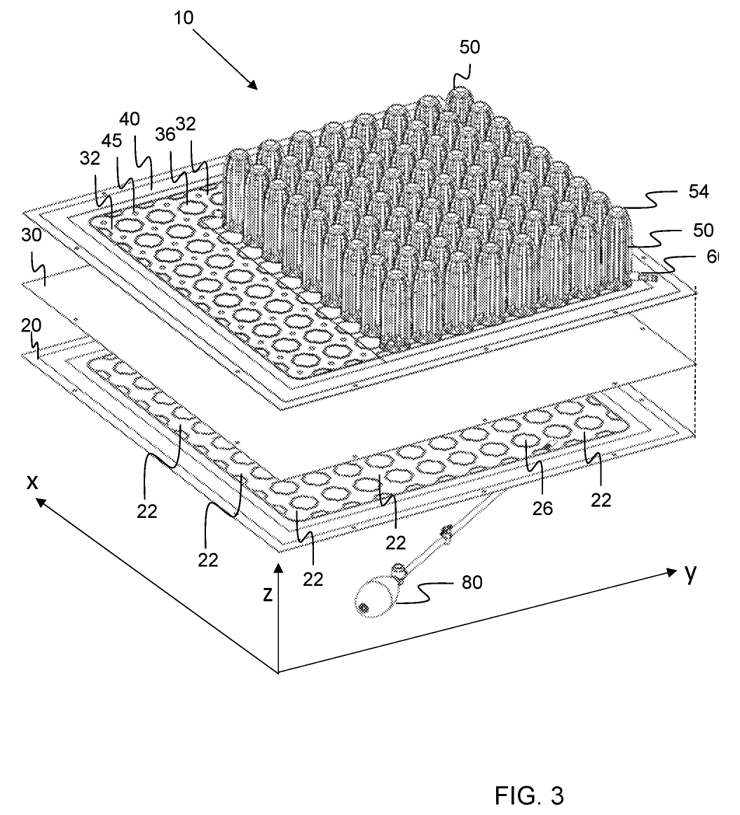

FIG. 3 shows an embodiment of the cellular cushion 10 in a perspective exploded view at an angle from above. The cellular cushion 10 is positioned in a Cartesian coordinate system comprising mutually perpendicular x, y and z-axes. The cellular cushion 10 comprises a lower layer 20 an intermediate layer 30, the upper layer 40 and the hollow cells 50. The lower layer 20, the intermediate layer 30 and the upper layer 40 each has its main extension in the x and y direction, i.e. they have their surfaces aligned with a plane extending in the x and y direction. The intermediate layer 30 is arranged on top of the lower layer 20. That the intermediate layer 30 is arranged on top of the lower layer 20 means that the lower layer 20 and the intermediate layer 30 have the same x and y position, or at least share the same x and y position, but they have different z positions. The upper layer 40 is arranged on top of the intermediate layer 30. That the upper layer 40 is arranged on top of the intermediate layer 30 means that the intermediate layer 30 and the upper layer 40 have the same x and y position, or at least share the same x and y position, but they have different z positions. That the plurality of hollow cells 50 are arranged on top of the upper layer 40 means that the upper layer 40 and the hollow cells 50 have the same x and y position, or at least share the same x and y position, but they have different z positions.

Further, the intermediate layer 30 is coupled to the lower layer 20 in such a way that first channels 22 for transport of a fluid are formed between the lower layer 20 and the intermediate layer 30. In the embodiment of FIG. 3, the pattern shown on the lower layer 20 comprises first areas 26 in an x-y plane within which boundaries the lower layer 20 is coupled to the intermediate layer 30. Further, outside the boundaries of the first areas 26, there is no coupling between the lower layer 20 and the intermediate layer 30. Consequently, in between the first areas 26 in the x-y plane and in between the lower layer 20 and the intermediate layer 30 in the z-direction, the first channels 22 are formed. The coupling between the lower layer 20 and the intermediate layer 30 may be formed by welding the intermediate layer 30 to the lower layer 20 at the first areas 26. The boundaries of the first areas 26 may then be called welding seams. The welding may be performed by warming up the lower and intermediate layers 20, 30 at the first areas 26 where they are to be coupled together and pressing the lower and intermediate layers 20, 30 towards each other at those first areas 26. Preferably, high-frequency welding is used, in which the lower and intermediate layers 20, 30 are warmed up by microwaves. The fluid to be transported in the first channels 22 is preferably air, but it can also be any other gaseous medium or even a liquid medium such as water.

Further, the upper layer 40 is coupled to the intermediate layer 30 in such a way that second channels 32 for transport of a fluid are formed between the intermediate layer 30 and the upper layer 40. In the embodiment of FIG. 3, the pattern shown on the upper layer 40 comprises second areas 36 in an x-y plane within which boundaries the upper layer 40 is coupled to the intermediate layer 30. Further, outside the boundaries of the second areas 36, there is no coupling between the upper layer 40 and the intermediate layer 30. Consequently, in between the second areas 36 in the x-y plane and in between the upper layer 40 and the intermediate layer 30 in the z-direction, the second channels 32 are formed. The coupling between the upper layer 40 and the intermediate layer 30 may be formed by welding the upper layer 40 to the intermediate layer 30 at the second areas 36. The boundaries of the second areas 36 may then be called welding seams. The welding may be performed by warming up the upper and intermediate layers 40, 30 at the second areas 36 where they are to be coupled together and pressing the upper and intermediate layers 40, 30 towards each other at those second areas 36. Preferably, high-frequency welding is used, in which the upper and intermediate layers 40, 30 are warmed up by microwaves. The fluid to be transported in the second channels 32 is preferably air, but it can also be any other gaseous medium or even a liquid medium such as water. In the embodiment of FIG. 3, the intermediate layer 30 has no pattern marked. As the first channels 22 are formed between the lower and intermediate layer 20, 30 and the second channels 32 are formed between the upper and intermediate layers 40, 30, the patterns forming the channels are only shown on two of the layers as it would be a bit misleading to show a third pattern on the intermediate layer as there is no separate third pattern.

Further, the first and second channels 22, 32 are sealed from each other so that there is no fluid communication between the first and second channels 22, 32. In other words, the first channels 22 constitute a first system of channels for transport of fluid between the lower layer 20 and the intermediate layer 30. The second channels 32 constitute a second system of channels for transport of fluid between the intermediate layer 30 and the upper layer 40. The second channels 32 are also in fluid communication with the plurality of hollow cells 50 as will now be described below.

Further, as shown in FIG. 3, the upper layer 40 has a plurality of holes 45. Each hole 45 is positioned at a respective one of the roots 53 (see FIG. 9) of the plurality of hollow cells 50. The plurality of hollow cells 50 are capable of being in fluid communication with each other through the plurality of holes 45 of the upper layer 40 and the second channels 32. According to an embodiment, the plurality of holes 45 in the upper layer 40 comprises at least one hole 45 per hollow cell 50. That a hole 45 is positioned at a root 53 of a hollow cell 50 means that the hole 45 and the root 53 share the same position in a plan view of the cellular cushion taken perpendicular to the upper layer 40. In other words, the hole 45 and the root 53 share the same position in the x-y plane. This means that there is a free passage of fluid from the second channels 32 to the hollow cells 50 via the holes 45 of the upper layer 40. According to an embodiment, the hole 45 is concentric with the root 53. Further, the root 53 defines the part of the hollow cell 50 that is closest to the intermediate layer 30.

Further, each hole 45 is smaller than the respective root 53. That each of the plurality of holes 45 is smaller than the root 53 of its respective hollow cell 50 means that each hole 45 has a cross-sectional area that is smaller than the cross-sectional area of the root 53. According to an embodiment, the plurality of holes 45 each has a circular cross-section. In alternative embodiments, other cross-sections of the holes 45 may be used, such as rectangular, triangular, elliptical, or polygonal. According to embodiments, the root 53 of each cell 50 may be 30-60 mm, more preferably 40-50 mm. Each hole 45 of the upper layer may be 3 – 25 mm, more preferably 5-15 mm. The smaller the size of the hole 45, the more secure the closing of the hole 45 when filling the first channels 22 with fluid and pressurizing the first channels 22. However, a smaller hole 45 results in lower fluid flow.

Still further, and as illustrated in FIG. 7, each of the plurality of hollow cells 50 and each of the holes 45 of the upper layer 40 are arranged on top of and aligned with at least one of the first channels 22. Hereby, when the first channels 22 are filled with fluid and pressurized, the intermediate layer 30 is pressed towards the upper layer 40, whereby the intermediate layer 30 closes the plurality of holes 45 of the upper layer 40 and/or the second channels 32. That each of the plurality of hollow cells 50 and each of the holes 45 of the upper layer 40 are positioned on top of and aligned with at least one first channel 22 signifies that the hollow cell 50 and the hole 45 have or share the same position as the at least one first channel 22 in a plan view of the cellular cushion 10 seen perpendicular to the lower layer 20, the intermediate layer 30 and/or the upper layer 40. In other words, the hollow cell 50 and the hole 45 have or share the same position in an x-y plane as defined in FIGS. 3 as well as in FIG. 7.

As mentioned, the intermediate layer 30 closes the plurality of holes 45 and/or the second channels 32 when the first channels 22 are filled with fluid and pressurized. As the first channels 22 are aligned with the plurality of holes 45, when filling the first channels 22 with fluid, the intermediate layer 30 will be pressed towards the upper layer 40 and especially the plurality of holes 45 of the upper layer 40. The plurality of holes 40 will hereby be closed and no fluid can move between the hollow cells 50. Also, as seen in FIG. 10, the second channels 32 can be closed at their parts leading in between the cells 50, and more specifically at entries or exits of the parts leading in between the cells. Such possible double closing of the connection between the cells, both at the channel parts leading in between the cells and at the holes of the upper layer will bring the risk of leakage between the cells 50 when they are locked to a minimum.

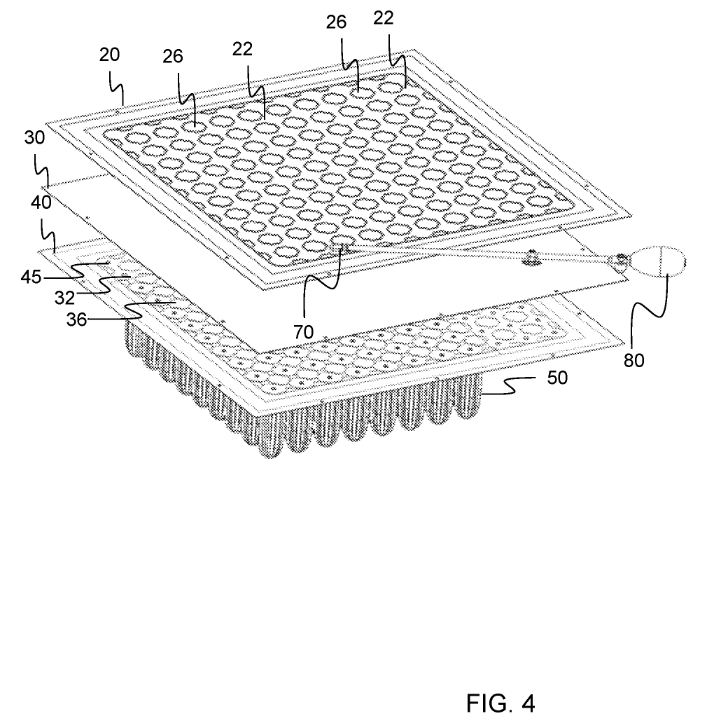

FIG. 4 shows an embodiment of the cellular cushion 10 in a perspective exploded view at an angle from below. As for FIG. 3, the pattern shown on the upper layer 40 defines the second channels 32 between the intermediate layer 30 and the upper layer 40 and the second areas 36 within which boundaries the upper layer 40 is coupled to the intermediate layer 30.

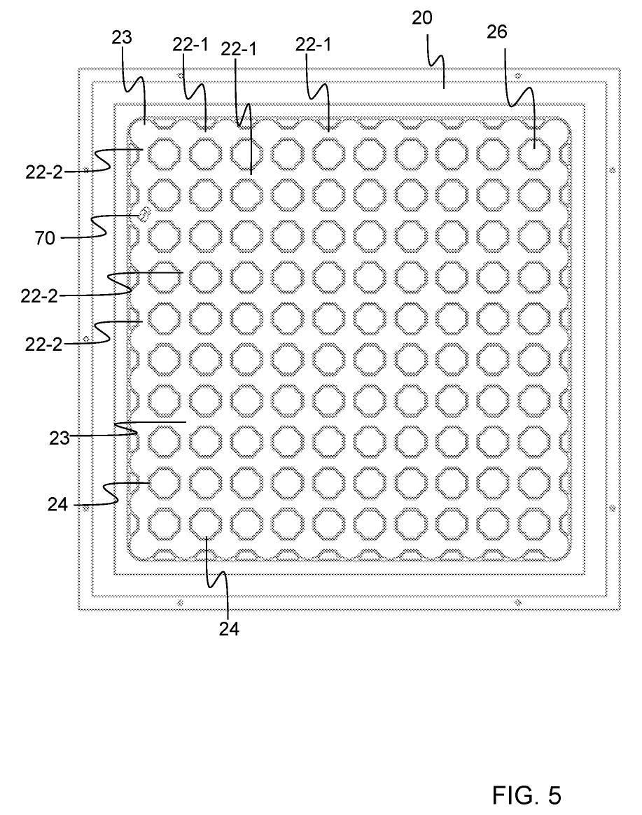

FIG. 5 is a plan view of an embodiment of the lower layer 20 including the first channels 22 formed between the lower layer 20 and the intermediate layer 30 when the intermediate layer 30 has been coupled to the lower layer 20 at the first areas 26. According to an embodiment shown in FIG. 5, the first channels 22 comprise a first set of first channels 22-1 and a second set of first channels 22-2. The first set of first channels 22-1 crosses the second set of first channels 22-2 at a plurality of first channel crossings 23. Further, the plurality of hollow cells 50 are arranged with their roots 53 on top of and aligned with the plurality of first channel crossings 23. Hereby, when the first channels 22 are pressurized with fluid, the intermediate layer 30 will more easily move towards the upper layer 40 at the first channel crossings 23 and thereby towards the roots 53 of the hollow cells 50 and consequently towards the holes 45 in the upper layer 40 than outside the first channel crossings 23. According to an embodiment, the first set of first channels 22-1 are mutually parallel. Also, the second set of first channels 22-2 are mutually parallel. Further, the first set of first channels 22-1 are preferably perpendicular to the second set of first channels 22-2.

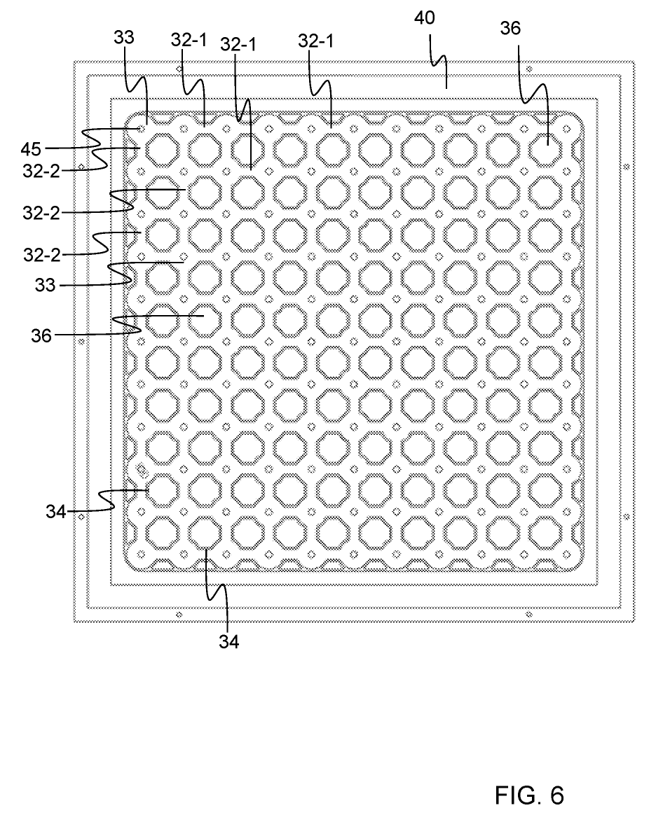

FIG. 6 is a plan view of an embodiment of the upper layer 40 including the second channels 32 formed between the upper layer 40 and the intermediate layer 30 when the upper layer 40 has been coupled to the intermediate layer 30 at the second areas 36. According to an embodiment shown in FIG. 6, the second channels 32 comprise a first set of second channels 32-1 and a second set of second channels 32-2. The first set of second channels 32-1 crosses the second set of second channels 32-2 at a plurality of second channel crossings 33. Further, the plurality of hollow cells 50 are arranged with their roots 53 on top of and aligned with the plurality of second channel crossings 33. Hereby, when the first channels 22 are pressurized with fluid, the intermediate layer 30 will more easily move towards the upper layer 40 at the second channel crossings 33 and thereby towards the roots 53 of the hollow cells 50 and consequently towards the holes 45 in the upper layer 40 than outside the second channel crossings 33. According to an embodiment, the first set of second channels 32-1 are mutually parallel. Also, the second set of second channels 32-2 are mutually parallel. Further, the first set of second channels 32-1 are preferably perpendicular to the second set of second channels 32-2.

According to another embodiment, indicated in FIGS. 5 and 6 together, each of the plurality of holes 45 of the upper layer 40 has the same position as one of the second channel crossings 33 in a plan view of the cellular cushion 10 perpendicular to the upper layer 40. This gives an even higher security for locking of the second channels 32 and/or the holes 45 of the upper layer 40 when filling the first channels 22 with fluid.

FIG. 7 shows the hollow cells 50 as well as the first channels 22 and the second channels 32 in a plan view from above, according to an embodiment. The first channels 22 comprise a first set of first channels 22-1 and a second set of first channels 22-2. The first set of first channels 22-1 crosses the second set of first channels 22-2 at a plurality of first channel crossings 23 (concealed by the hollow cells in FIG. 7 but shown in FIG. 6). The second channels 32 comprise a first set of second channels 32-1 and a second set of second channels 32-2. The first set of second channels 32-1 crosses the second set of second channels 32-2 at a plurality of second channel crossings 33 (concealed by the hollow cells in FIG. 7 but shown in FIG. 6). As further shown in FIG. 7, the second channels 32 are arranged on top of and aligned with the first channels 22. Hereby, a very secure closing of the second channels 32 and/or the holes 45 of the upper layer 40 is achieved when the first channels 22 are filled with fluid. According to a variant of this embodiment, the second channels 32 are congruent with the first channels 22 and the second channels 32 have the same position as the first channels 22 in a plan view of the cellular cushion 10 perpendicular to the upper layer 40. Hereby, the cellular cushion 10 can be manufactured more quickly as mounting of the upper layer 40 to the intermediate layer 30 and the intermediate layer 30 to the lower layer 20 for creation of the first and second channels can be made simultaneously. The upper layer may be mounted to the intermediate layer and the intermediate layer to the lower layer for example by welding, which will be explained in more detail below.

According to a further embodiment, and as shown in FIG. 7, a center point in the x-y plane of each hollow cell 50 coincides with a center point in the x-y plane of one of the first crossings 23 between the first set of first channels 22-1 and the second set of first channels 22-2. Also, the center point in the x-y plane of each hollow cell 50 coincides with a center point in the x-y plane of one of the second crossings 33 between the first set of second channels 32-1 and the second set of second channels 32-2.

According to another embodiment, the plurality of hollow cells 50 are formed unitarily with the upper layer 40. In other words, the upper layer 40 and the plurality of hollow cells 50 constitute the same layer.

According to another embodiment, which is shown in FIG. 8, the cellular cushion further comprises a hollow cell layer 55. The hollow cell layer 55 comprises the plurality of hollow cells 50, the hollow cell layer 55 is arranged on top of the upper layer 40 and coupled to the upper layer 40. In such an embodiment, there are in total four layers, the lower layer 20, the intermediate layer 30, the upper layer 40 and the hollow cell layer 55. In this embodiment, the root 53 of each hollow cell is an opening 52 with the same size cross-sectional size as the cross-section of the cell and the cross-section of the root. The hollow cell layer 55 is then positioned on top of the upper layer 40 and coupled to the upper layer 40 so that each hole 45 of the upper layer 40 is within the opening 52 of one of the cells 50. The cross-sectional area of each of the plurality of holes 45 is then smaller than the cross-sectional area of each of the openings 52. According to an embodiment, the hollow cell layer 55 is made of rubber. According to another embodiment, which may be combined with the above, the hollow cell layer 55 is coupled to the upper layer by being glued to the upper layer 40. According to other embodiments, the hollow cell layer 55 is coupled to the upper layer by any other adhesive method or arrangement, such as using tape with adhesive on both sides, meltable tape or glue, etc.

According to an embodiment, the cellular cushion further comprises a first valve 60 connected to one of the plurality of hollow cells 50 or to one of the second channels 32 for inflating and deflating of the plurality of hollow cells 50 and a second valve 70 connected to one of the first channels 22 for inflating and deflating of the first channels 22.

According to an embodiment, the lower layer 20 and the intermediate layer 30 are made of plastic, preferably thermoplastic polyurethane (TPU).

According to an embodiment, the plurality of hollow cells 50 are made of rubber, preferably polychloroprene. For the embodiment where the plurality of hollow cells 50 are a part of a hollow cell layer 55 that is separate from the upper layer 40, the upper layer 40 may be made of TPU and the hollow cell layer 55 may be made of polychloroprene.

According to an embodiment shown in FIG. 5, the intermediate layer 30 is coupled to the lower layer 20 by first welding seams 24, the first welding seams delimiting the first channels 22. According to an embodiment shown in FIG. 6, the upper layer 40 is coupled to the intermediate layer 30 by second welding seams 34, the second welding seams delimiting the second channels 32.

Disclosed is also a method for manufacturing a cellular cushion 10 as described in any of the above embodiments. Such a method comprises welding the intermediate layer 30 to the lower layer 20 so that the first welding seams 24 are created, the first welding seams delimiting the first channels 22, and welding the upper layer 40 to the intermediate layer 30 so that the second welding seams 34 are created, the second welding seams delimiting the second channels 32. In other words, the welding is performed so that in positions where the first channels 22 are to run, the intermediate layer 30 is not welded to the lower layer 20, and in positions where the second channels 32 are to run, the upper layer 40 is not welded to the intermediate layer 30. The welding is performed by warming up the layers where they are to be welded, i.e. where the first/second welding seams 24, 34 are to be and at the first/second areas 26, 36 defined as inside the first/second welding seems 24, 34, while pressing the layers towards each other. Preferably, high-frequency welding is used, in which the layers are warmed up by microwaves.

According to an embodiment, the welding of the intermediate layer 30 to the lower layer 20 and the welding of the upper layer 40 to the intermediate layer 30 are performed simultaneously in one step, so that the first channels 22 and the second channels 32 will be congruent and arranged in the same position in a plan view of the cellular cushion 10 perpendicular to the upper layer 40. Hereby, a quick and secure manufacturing process is achieved.

According to another embodiment, for the embodiment of the cellular cushion 10 comprising four layers, i.e. the lower layer 20, the intermediate layer 30, the upper layer 40 and the hollow cell layer 55, the method also comprises glueing the hollow cell layer 5 to the upper layer 40.

According to another embodiment, the manufacturing method also comprises making the holes 45 in the upper layer 40 before the steps of welding and the possible step of glueing.

FIGS. 9 and 10 show an embodiment of the cellular cushion of FIG. 1 in a side view as well as a close-up in a vertical cross-section A-A of FIG. 1. In FIG. 9, the first channels 22 have not been inflated via the arrangement 80 for inflating or deflating the first channels, e.g. a pump. As indicated by the white arrows in the close-up view, fluid can then move freely between the hollow cells 50 via the second channels 32 extending between the intermediate layer 30 and the upper layer 40. In FIG. 10, the first channels 22 have been inflated by the pump 80. The intermediate layer 30 is now pressed by the pressure of the fluid in the first channels 22 towards the upper layer 40 at the positions in the x-y plane where the holes 45 in the upper layer 40 and the hollow cells 50 are situated. As seen, the intermediate layer 30 closes the holes 45 of the upper layer 40 as well as the second channels 32 in between neighboring hollow cells 50, as marked with a plurality of white “x” in FIG. 10. Hereby, a secure closing of the second channels 32 is achieved. The smaller the holes 45 of the upper layer 40, the more secure the closing of the connection between the hollow cells 50 via the second channels 32.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean "one and only one" unless explicitly so stated, but rather "one or more." All structural and functional equivalents to the elements of the above-described embodiments that are known to those of ordinary skill in the art are expressly incorporated herein by reference and are intended to be encompassed hereby. Moreover, it is not necessary for the cellular cushion or the method to address each and every problem sought to be solved by the presently described concept, for it to be encompassed hereby.

What is claimed is:

1. A cellular cushion comprising:
a lower layer,
an intermediate layer arranged on top of the lower layer and coupled to the lower layer in such a way that first channels for transport of a fluid are formed between the lower layer and the intermediate layer,
an upper layer arranged on top of the intermediate layer and coupled to the intermediate layer in such a way that second channels for transport of fluid are formed between the upper layer and the intermediate layer, and
a plurality of hollow cells coupled to the upper layer, each of the plurality of hollow cells having a root defined at the upper layer and a tip, each cell extending from the root away from the upper layer towards the tip,
wherein the upper layer has a plurality of holes, each hole positioned at a respective one of the roots of the plurality of hollow cells, each hole being smaller than the respective root,
wherein the plurality of hollow cells are capable of being in fluid communication with each other through the plurality of holes of the upper layer and the second channels, wherein each of the plurality of hollow cells and each of the holes of the upper layer are arranged on top of and aligned with at least one of the first channels, whereby, when the first channels are filled with fluid and pressurized, the intermediate layer is pressed towards the upper layer, whereby the intermediate layer closes the plurality of holes of the upper layer and/or the second channels.

2. The cellular cushion according to claim 1, wherein the plurality of hollow cells are formed unitarily with the upper layer.

3. The cellular cushion according to claim 1, further comprising a hollow cell layer comprising the plurality of hollow cells, the hollow cell layer being arranged on top of the upper layer and coupled to the upper layer.

4. The cellular cushion according to claim 1, wherein the second channels are arranged on top of and aligned with the first channels.

5. The cellular cushion according to claim 4, wherein the second channels are congruent with the first channels and the second channels have the same position as the first channels in a plan view of the cellular cushion perpendicular to the upper layer.

6. The cellular cushion according to claim 1, wherein the first channels comprise a first set of first channels (22-1) and a second set of first channels (22-2), wherein the first set of first channels (22-1) crosses the second set of first channels (22-2) at a plurality of first channel crossings, wherein the plurality of hollow cells are arranged with their roots on top of and aligned with the plurality of first channel crossings.

7. The cellular cushion according to claim 1, wherein the second channels comprise a first set of second channels (32-1) and a second set of second channels (32-2), wherein the first set of second channels (32-1) crosses the second set of second channels (32-2) at a plurality of second channel crossings, wherein the plurality of hollow cells are arranged with their roots on top of and aligned with the plurality of second channel crossings.

8. The cellular cushion according to claim 7, wherein each of the plurality of holes of the upper layer has the same position as a respective one of the second channel crossings in a plan view of the cellular cushion perpendicular to the upper layer.

9. The cellular cushion according to claim 1, further comprising:
a first valve connected to one of the plurality of hollow cells or to one of the second channels for inflating and deflating of the plurality of hollow cells, and
a second valve connected to one of the first channels for inflating and deflating of the first channels.

10. The cellular cushion according to claim 1, wherein the lower layer and the intermediate layer are made of plastic, preferably thermoplastic polyurethane, TPU.

11. The cellular cushion according to claim 1, wherein the plurality of hollow cells are made of rubber, preferably polychloroprene.

12. The cellular cushion according to claim 1, wherein the intermediate layer is coupled to the lower layer by welding seams, the welding seams delimiting the first channels, and
wherein, preferably, the upper layer is coupled to the intermediate layer by second welding seams, the second welding seams delimiting the second channels.

13. A method for manufacturing a cellular cushion according to claim 1, comprising:
welding the intermediate layer to the lower layer so that first welding seams are created, the first welding seams delimiting the first channels, and
welding the upper layer to the intermediate layer so that second welding seams are created, the second welding seams delimiting the second channels.

14. The method according to claim 13, wherein the welding of the intermediate layer to the lower layer and the welding of the upper layer to the intermediate layer are performed simultaneously in one step, so that the first channels and the second channels will be congruent and arranged in the same position in a plan view of the cellular cushion perpendicular to the upper layer.

15. The method according to claim 13, wherein the cellular cushion further includes a hollow cell layer comprising the plurality of hollow cells, the hollow cell layer being arranged on top of the upper layer and coupled to the upper layer for manufacturing a cellular cushion and the method further comprises glueing or taping the hollow cell layer to the upper layer.
